(19) United States
(12) Patent Application Publication
(10) Pub. No.: US 2022/0171250 A1
(43) Pub. Date: Jun. 2, 2022

(54) DISPLAY DEVICE

(71) Applicant: Japan Display Inc., Tokyo (JP)

(72) Inventors: Tetsuro OCHI, Tokyo (JP); Kazuyoshi YOSHIDA, Tokyo (JP); Taro ICHIMURA, Tokyo (JP)

(21) Appl. No.: 17/675,100

(22) Filed: Feb. 18, 2022

Related U.S. Application Data
(63) Continuation of application No. PCT/JP2020/027502, filed on Jul. 15, 2020.

(30) Foreign Application Priority Data
Aug. 27, 2019 (JP) 2019-154631

(51) Int. Cl. G02F 1/1685; G09G 3/34; G02F 1/167; G02F 1/1676; G02F 1/1343; G02F 1/16755; G02F 1/16757

(52) U.S. Cl. CPC G02F 1/1685; G09G 3/344; G02F 1/167; G02F 1/16757; G02F 1/134309; G02F 1/16755; G02F 1/1676

(57) ABSTRACT

According to one embodiment, a display device comprises a first drive substrate comprising a first base having a first end portion, a plurality of first pixel electrodes, and a first drive circuit, a second drive substrate comprising a second base having a second end portion, a plurality of second pixel electrodes, and a second drive circuit, and a counter-substrate comprising a support base and an electrophoretic layer. The first end portion and the second end portion are in contact with each other to form a contact portion. The electrophoretic layer overlaps the plurality of first pixel electrodes, the first drive circuit, the contact portion, the second drive circuit, and the plurality of second pixel electrodes.

### CROSS-REFERENCE TO RELATED APPLICATIONS

This application is a Continuation Application of PCT Application No. PCT/JP2020/027502, filed Jul. 15, 2020 and based upon and claiming the benefit of priority from Japanese Patent Application No. 2019-154631, filed Aug. 27, 2019, the entire contents of all of which are incorporated herein by reference.

### FIELD

The embodiment of the present invention relates to a display device.

### BACKGROUND

As an example of a display device, an electrophoretic display device has been proposed in which an electrophoretic element is sandwiched between an element substrate and a counter-substrate. In this type of electrophoretic display device, a peripheral circuit or the like is provided in a non-display area around a display area, and a frame that does not contribute to display is formed. In recent years, there has been a demand for a larger screen of a display device. In response to such a demand, a tiling technique for coupling a plurality of display devices is known.

### BRIEF DESCRIPTION OF THE DRAWINGS

FIG. 1 is a perspective view illustrating a display device DSP of a first embodiment.

FIG. 2A is a perspective view illustrating a display device DSP including a moisture-proof material 5.

FIG. 2B is a perspective view illustrating the display device DSP including the moisture-proof material 5.

FIG. 3 is a cross-sectional view of the display device DSP taken along line A-B illustrated in FIG. 2A.

FIG. 4 is a cross-sectional view enlarging a part of the display device DSP illustrated in FIG. 3.

FIG. 5 is a cross-sectional view illustrating a display device DSP of a second embodiment.

FIG. 6A is a plane view of the display device DSP including a conductive layer 50 illustrated in FIG. 5.

FIG. 6B is another plane view of the display device DSP including the conductive layer 50 illustrated in FIG. 5.

FIG. 7A is a cross-sectional view illustrating a display device DSP of a third embodiment.

FIG. 7B is a plane view of the display device DSP including a first electrode 61 and a second electrode 62 illustrated in FIG. 7A.

FIG. 7C is another plane view of the display device DSP including the first electrode 61 and the second electrode 62 illustrated in FIG. 7A.

FIG. 8 is a perspective view illustrating a configuration example of the first electrode 61 applicable to the third embodiment.

FIG. 9 is a cross-sectional view illustrating a display device DSP of a fourth embodiment.

FIG. 10 is a perspective view illustrating a configuration example of the first electrode 61 applicable to the fourth embodiment.

FIG. 11 is a perspective view illustrating another configuration example of the first electrode 61 applicable to the fourth embodiment.

FIG. 12A is a plane view for explaining a configuration example of connection between a pixel electrode 14A and an electrode element 61A illustrated in FIG. 10.

FIG. 12B is a plane view for explaining another configuration example of connection between the pixel electrode 14A and the electrode element 61A illustrated in FIG. 10.

FIG. 13 is a perspective view of bases 10A and 10B of a fifth embodiment as viewed from an upper surface 1U side.

FIG. 14 is a perspective view of bases 10A and 10B of the fifth embodiment as viewed from a lower surface 1L side.

FIG. 15 is a plane view illustrating a display device DSP of a sixth embodiment.

FIG. 16 is a cross-sectional view of the display device DSP illustrated in FIG. 15.

FIG. 17 is a plane view illustrating a display device DSP of a seventh embodiment.

### DETAILED DESCRIPTION

In general, according to one embodiment, a display device comprises: a first drive substrate comprising a first base having a first end portion, a plurality of first pixel electrodes arranged along the first end portion, and a first drive circuit provided between the plurality of first pixel electrodes and the first end portion; a second drive substrate that is separate from the first drive substrate and comprises a second base having a second end portion in contact with the first end portion, a plurality of second pixel electrodes arranged along the second end portion, and a second drive circuit provided between the plurality of second pixel electrodes and the second end portion; and a counter-substrate comprising a support base opposed to the first drive substrate and the second drive substrate, and an electrophoretic layer provided between the first drive substrate and the support base and between the second drive substrate and the support base, wherein the first end portion of the first base and the second end portion of the second base are in contact with each other to form a contact portion, and the electrophoretic layer overlaps the plurality of first pixel electrodes, the first drive circuit, the contact portion, the second drive circuit, and the plurality of second pixel electrodes.

According to one embodiment, it is possible to provide a display device capable of achieving a large screen.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

### First Embodiment

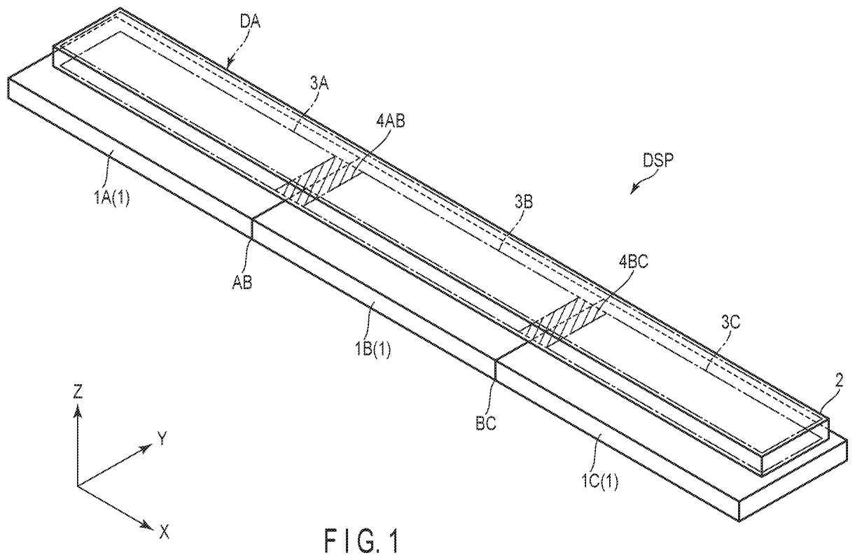

FIG. 1 is a perspective view illustrating a display device DSP of a first embodiment. The display device DSP includes a plurality of drive substrates 1 and a counter-substrate 2. The number of counter-substrates 2 is smaller than the number of drive substrates. In the example illustrated, one display device DSP includes three drive substrates 1A, 1B, and 1C and one counter-substrate 2. Here, for convenience, a direction in which a longer side of the display device DSP extends is referred to as a first direction X, a direction in which a shorter side of the display device DSP extends is referred to as a second direction Y, and a thickness direction of the display device DSP is referred to as a third direction Z. For example, the first direction X, the second direction Y, and the third direction Z are orthogonal to each other, but may intersect at an angle other than 90 degrees. In addition, viewing an X-Y plane defined by the first direction X and the second direction Y is referred to as a planar view.

In the display device DSP, the drive substrate 1 is provided on the back side of the counter-substrate 2, and the counter-substrate 2 is provided on a display surface side. The drive substrate 1 may be referred to as a backplane, and the counter-substrate 2 may be referred to as a front plane.

Each of the drive substrates 1A, 1B, and 1C is formed in a rectangular shape extending in the first direction X. The drive substrates 1A, 1B, and 1C are arranged in the first direction X and are in contact with each other. In other words, the drive substrates 1A and 1B form a contact portion AB with which their shorter sides opposed to each other in the first direction X are in contact. In addition, the drive substrates 1B and 1C form a contact portion BC with which their shorter sides opposed to each other in the first direction X are in contact. Incidentally, the term “contact” between the substrates here includes not only a state in which the substrates abut on each other but also a state in which the substrates are opposed to each other with a slight gap interposed therebetween and are provided close to each other to such an extent that the gap can be ignored in terms of structure.

The drive substrates 1A, 1B, and 1C have active areas 3A, 3B, and 3C, respectively. Each of the active areas 3A, 3B, and 3C is formed in a rectangular shape extending in the first direction X. The active areas 3A, 3B, and 3C correspond to areas surrounded by dash-dotted lines in the drawing.

In the drive substrates 1A and 1B, a sub-area 4AB across the contact portion AB is provided between the active areas 3A and 3B arranged in the first direction X. In addition, in the drive substrates 1B and 1C, a sub-area 4BC across the contact portion BC is provided between the active areas 3B and 3C arranged in the first direction X. The sub-areas 4AB and 4BC correspond to areas indicated by hatching in the drawing.

The counter-substrate 2 is formed in a rectangular shape extending in the first direction X. With respect to the length along the first direction X, the counter-substrate 2 is longer than one drive substrate 1. In the example illustrated in FIG. 1, the length of the counter-substrate 2 is equal to the length of three drive substrates 1. The counter-substrate 2 is opposed to the drive substrates 1A, 1B, and 1C in the third direction Z, and is bonded to the drive substrates 1A, 1B, and 1C. In addition, the counter-substrate 2 overlaps the three active areas 3A, 3B, and 3C and the two sub-areas 4AB and 4BC. The active areas 3A, 3B, and 3C and the sub-areas 4AB and 4BC overlap an electrophoretic layer described later, which allows a display area DA for displaying an image to be formed. That is, by disposing a single counter-substrate 2 on the plurality of drive substrates 1 while arranging the plurality of drive substrates 1 in abutment with each other, the plurality of active areas and the sub-areas between the active areas are connected to form a single display area DA, and a joint between the drive substrates 1 adjacent to each other is hardly visually recognized. Therefore, it is possible to easily increase the screen size of the display device DSP by laying drive substrates having the same structure.

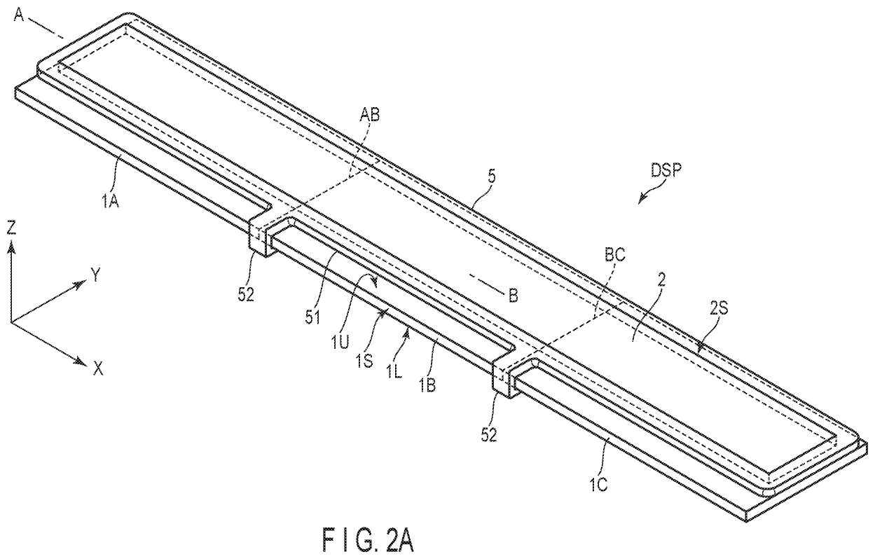

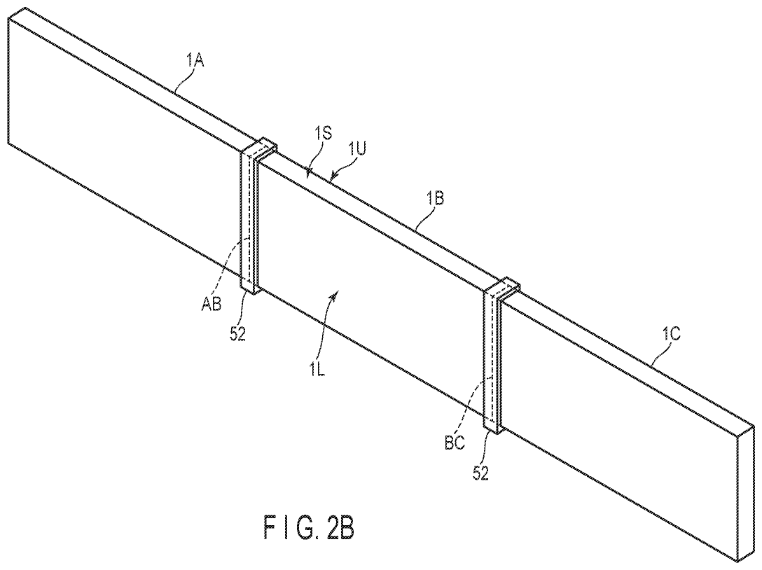

FIGS. 2A and 2B are perspective views illustrating the display device DSP including a moisture-proof material 5. Incidentally, FIG. 2A corresponds to a perspective view of the display device DSP as viewed from the upper surface side, and FIG. 2B corresponds to a perspective view of the display device DSP as viewed from the lower surface side. The configurations of the drive substrates 1A, 1B, and 1C and the counter-substrate 2 are as described with reference to FIG. 1.

The moisture-proof material 5 includes a first part 51 and a second part 52. The first part 51 covers the entire circumference of a side surface 2S of the counter-substrate 2. In addition, the first part 51 is formed in a frame shape in planar view and intersects the contact portions AB and BC. The second part 52 covers the contact portions AB and BC, respectively. In other words, the second part 52 is provided on each of an upper surface (in particular, a part where the counter-substrate 2 does not overlap) 1U, a lower surface 1L, and a side surface 1S of each drive substrate 1. The second part 52 is in communication with the first part 51 at an intersection with the contact portion AB and an intersection with the contact portion BC in the first part 51. Such moisture-proof material 5 is formed of a material that prevents ingress of moisture or the like into an adhesive layer or an electrophoretic layer described later.

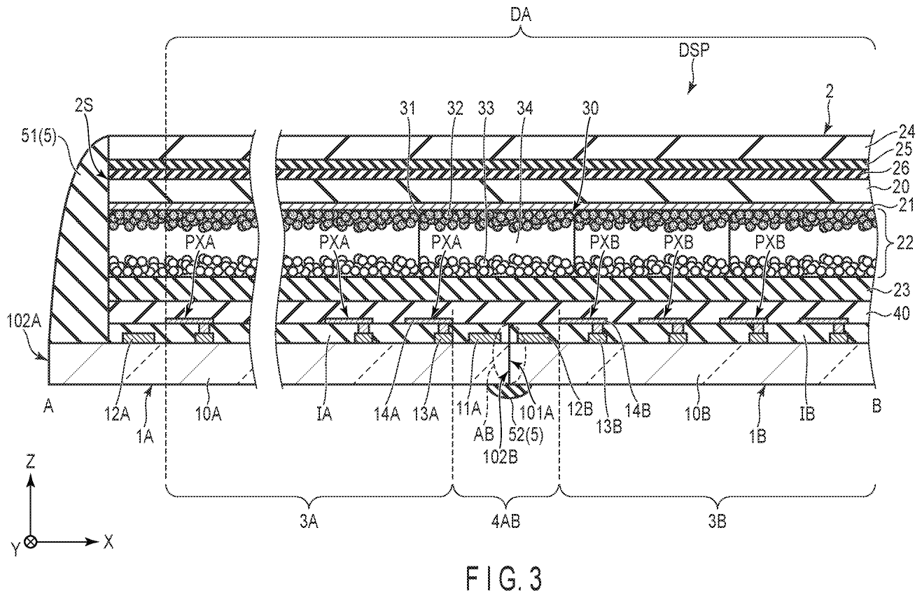

FIG. 3 is a cross-sectional view of the display device DSP taken along line A-B illustrated in FIG. 2A. The drive substrate 1A includes a base 10A, drive circuits 11A and 12A, a switching element 13A, a pixel electrode 14A, and the like. The drive substrate 1B includes a base 10B, a drive circuit 12B, a switching element 13B, a pixel electrode 14B, and the like.

The bases 10A and 10B are insulating substrates formed of the same material, for example, glass or synthetic resin. The base 10A has end portions 101A and 102A along the first direction X. The base 10B has an end portion 102B along the first direction X. The end portion 101A and the end portion 102B are in contact with each other to form a contact portion AB.

In the drive substrate 1A, the active area 3A includes a plurality of pixels PXA. In each pixel PXA, the pixel electrode 14A is electrically connected to the switching element 13A. The pixel electrode 14A is located on an insulating film IA. The drive circuit 11A is provided between the pixel electrode 14A located at the outermost periphery of the active area 3A and the end portion 101A in the first direction X. The drive circuit 11A is covered with the insulating film IA.

In the drive substrate 1B, the active area 3B includes a plurality of pixels PXB. In each pixel PXB, the pixel electrode 14B is electrically connected to the switching element 13B. The pixel electrode 14B is located on an insulating film IB. The drive circuit 12B is provided between the pixel electrode 14B located at the outermost periphery of the active area 3B and the end portion 102B in the first direction X. The drive circuit 12B is covered with the insulating film IB.

The drive circuits 11A and 12B are located between the active areas 3A and 3B adjacent to each other or in the sub-area 4AB. The drive circuit 11A described here includes a control circuit necessary for driving each pixel PXA in the active area 3A, and includes, for example, a gate driver for controlling on/off of the switching element 13A, but may include another circuit such as a source driver for supplying the pixel electrode 14A with a pixel potential. The drive circuit 12B is also configured in the same manner as the drive circuit 11A.

The counter-substrate 2 includes a support base 20, a common electrode 21, an electrophoretic layer 22, a base 23, and the like. The support base 20 is opposed to the drive substrates 1A and 1B in the third direction Z. The electrophoretic layer 22 is provided between the drive substrate 1A and the support base 20 and between the drive substrate 1B and the support base 20. In addition, the electrophoretic layer 22 overlaps the contact portion AB and the drive circuits 11A and 12B. The common electrode 21 is provided between the support base 20 and the electrophoretic layer 22. The common electrode 21 and the electrophoretic layer 22 are held between the support base 20 and the base 23. The support base 20, the common electrode 21, and the base 23 continuously extend without interruption at a position overlapping the contact portion AB.

The electrophoretic layer 22 includes a plurality of microcapsules 30 dispersedly disposed between the support base 20 and the base 23. Each microcapsule 30 includes an outer shell 31, a plurality of black particles 32, a plurality of white particles 33, and a dispersion medium 34. The black particles 32, the white particles 33, and the dispersion medium 34 are accommodated in the outer shell 31. The black particles 32 and the white particles 33 may also be referred to as electrophoretic particles. The outer shell 31 is formed of, for example, a transparent resin such as an acrylic resin. The dispersion medium 34 is a liquid that disperses the black particles 32 and the white particles 33 in the outer shell 31. Incidentally, in addition to the black particles 32 and the white particles 33, the microcapsules 30 may include electrophoretic particles of other colors such as red, green, blue, yellow, cyan, and magenta. In addition, the above-mentioned electrophoretic particles of other colors may be replaced with at least one of the black particles 32 and the white particles 33.

At least one of the plurality of microcapsules 30 overlaps the contact portion AB and the drive circuits 11A and 12B.

In addition, in the example illustrated in FIG. 3, the counter-substrate 2 has a barrier structure for preventing ingress of moisture or the like, and includes a base 24, a barrier layer 25, and a bonding layer 26. The barrier layer 25 is provided between the support base 20 and the base 24. The bonding layer 26 bonds the support base 20 to the barrier layer 25.

The support base 20 and the bases 23 and 24 are transparent insulating substrates formed of, for example, glass or synthetic resin. The common electrode 21 is a transparent electrode. The barrier layer 25 is a transparent inorganic insulating film. The bonding layer 26 is transparent.

A conductive adhesive layer 40 is provided between the drive substrate 1A and the counter-substrate 2 and between the drive substrate 1B and the counter-substrate 2 over substantially the entire surface. The base 23 of the counter-substrate 2 is stuck to the drive substrates 1A and 1B with the adhesive layer 40.

The first part 51 of the moisture-proof material 5 covers the side surface 2S of the counter-substrate 2 on the drive substrate 1A. That is, the first part 51 is in contact with the end portions of the support base 20, the common electrode 21, the electrophoretic layer 22, the base 23, the base 24, the barrier layer 25, and the bonding layer 26. The first part 51 is also in contact with the end portion of the adhesive layer 40. The second part 52 of the moisture-proof material 5 covers the contact portion AB.

Though not illustrated in FIG. 3, the drive substrate 1C is also configured in the same manner as the drive substrate 1A and the like. The counter-substrate 2 is stuck to the drive substrate 1C with the adhesive layer 40.

In the example illustrated in FIG. 3, the drive substrate 1A corresponds to a first drive substrate, the base 10A corresponds to a first base, the end portion 101A corresponds to a first end portion, the pixel electrode 14A corresponds to a first pixel electrode, and the drive circuit 11A corresponds to a first drive circuit. The drive substrate 1B corresponds to a second drive substrate, the base 10B corresponds to a second base, the end portion 102B corresponds to a second end portion, the pixel electrode 14B corresponds to a second pixel electrode, and the drive circuit 12B corresponds to a second drive circuit.

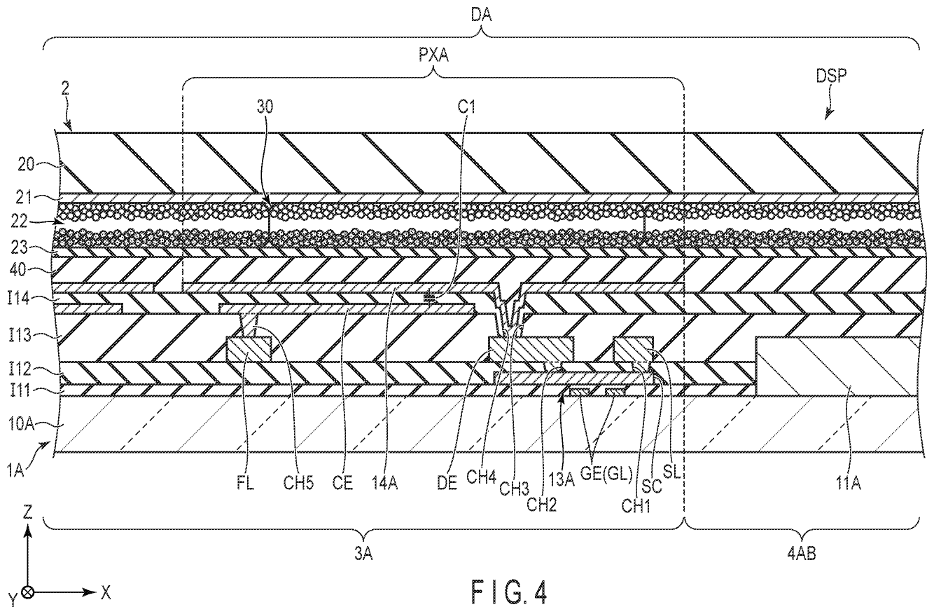

FIG. 4 is a cross-sectional view enlarging a part of the display device DSP illustrated in FIG. 3. Incidentally, an area including the outermost peripheral pixel PXA and the drive circuit 11A in the drive substrate 1A is enlarged and illustrated here. In addition, in the counter-substrate 2, the base 24, the barrier layer 25, and the bonding layer 26 are not illustrated.

The drive substrate 1A further includes insulating films I11 to I14, a power supply line FL, and a capacitive electrode CE, in addition to the drive circuit 11A, the switching element 13A, and the pixel electrode 14A. The insulating films I11 to I14 are included in the insulating film IA illustrated in FIG. 3. The switching element 13A is a thin-film transistor (TFT), and includes a semiconductor layer SC, a gate electrode GE, and a drain electrode DE. The illustrated switching element 13A has a double-gate structure, but may have a single-gate structure. The switching element 13A has a bottom-gate structure in which the gate electrode GE is disposed under the semiconductor layer SC, but may have a top-gate structure in which the gate electrode GE is disposed on the semiconductor layer SC.

The gate electrode GE electrically connected to a scanning line GL is located on the base 10A and is covered with the insulating film I11. The semiconductor layer SC is located on the insulating film I11 and is covered with the insulating film I12. The semiconductor layer SC is formed of, for example, polycrystalline silicon (e.g., low temperature polysilicon), but may be formed of amorphous silicon or an oxide semiconductor. The power supply line FL, a signal line SL, and the drain electrode DE are located on the insulating film I12 and are covered with the insulating film I13. The signal line SL is in contact with the semiconductor layer SC in a through hole CH1 penetrating the insulating film I12. The drain electrode DE is in contact with the semiconductor layer SC in a through hole CH2 penetrating the insulating film I12.

The drive circuit 11A includes a plurality of thin-film transistors, but detailed illustration thereof is omitted. The drive circuit 11A is covered with the insulating film I13.

The capacitive electrode CE is located on the insulating film I13 and is covered with the insulating film I14. The capacitive electrode CE is in contact with the power supply line FL in a through hole CH5 penetrating the insulating film I13.

The pixel electrode 14A is located on the insulating film I14. The pixel electrode 14A is in contact with the drain electrode DE in a through hole CH3 penetrating the insulating film I13 and a through hole CH4 penetrating the insulating film I14. The pixel electrode 14A overlaps the capacitive electrode CE with the insulating film I14 interposed therebetween to form a capacitance Cl of the pixel PXA.

The insulating films I11, I12, and I14 are, for example, inorganic insulating films. The insulating film I13 is, for example, one or more organic insulating films. The capacitive electrode CE and the pixel electrode 14A are transparent electrodes formed of, for example, a transparent conductive material such as indium tin oxide (ITO) or indium zinc oxide (IZO). The pixel electrode 14A or the capacitive electrode CE may include a reflecting electrode (metal electrode). Alternatively, in each pixel PXA, a reflecting electrode may be provided between the base 10A and the electrophoretic layer 22.

In the counter-substrate 2, the common electrode 21 and the electrophoretic layer 22 are disposed so as to overlap the drive circuit 11A. The common electrode 21 has the same electric potential as the capacitive electrode CE. In the microcapsules 30, the black particles 32 and the white particles 33 are charged in opposite polarities with each other. For example, the black particles 32 are positively charged and the white particles 33 are negatively charged.

In the display device DSP having the above configuration, when the pixel PXA displays black, the pixel electrode 14A is held at a relatively higher electric potential than the common electrode 21. That is, when the electric potential of the common electrode 21 is set as a reference potential, the pixel electrode 14A is held in positive polarity. Therefore, positively charged black particles 32 are attracted to the common electrode 21, while negatively charged white particles 33 are attracted to the pixel electrode 14A. As a result, when the pixel PXA is observed from above the counter-substrate 2, black is visually recognized.

In contrast, when the pixel PXA displays white, the pixel electrode 14A is held at a relatively lower electric potential than the common electrode 21. That is, when the electric potential of the common electrode 21 is set as a reference potential, the pixel electrode 14A is held in negative polarity. Therefore, negatively charged white particles 33 are attracted toward the common electrode 21 side, while positively charged black particles 32 are attracted to the pixel electrode 14A. As a result, when the pixel PXA is observed, white is visually recognized.

In the sub-area 4AB where the drive circuit 11A is provided, no pixel electrode is provided directly above the drive circuit 11A. However, as described above, the common electrode 21 and the electrophoretic layer 22 are provided directly above the drive circuit 11A. For this reason, when the pixel PXA located at the outermost periphery of the active area 3A is driven, the pixel electrode 14A is supplied with a pixel potential, so that an electric field is formed in the pixel PXA, and the electric field also spreads directly above the drive circuit 11A. In other words, in both the pixel PXA and the sub-area 4AB, an electric field is formed between the pixel electrode 14A and the common electrode 21. In other words, the pixel electrode 14A is provided along the boundary between the active area 3A and the sub-area 4AB, and as a result, the electric field generated by the pixel electrode 14A spreads not only to the active area 3A but also to a part of the sub-area 4AB. In addition, the width of the sub-area 4AB is significantly narrow, and the width thereof is only enough to dispose the drive circuit 11A. For this reason, the electrophoretic layer 22 directly above the drive circuit 11A is driven, and the same color is visually recognized in the pixel PXA and the sub-area 4AB. In short, a display area DA is formed not only in an area overlapping the active area 3A but also in an area overlapping the sub-area 4AB. The electric field of the pixel located at the outermost periphery of the active area also similarly spreads directly above the other drive circuits or in the other sub-area, and the electrophoretic layer 22 is driven as well as the outermost peripheral pixel. Therefore, an image can be displayed over a wider range than the active area of each drive substrate, and the image can also be displayed at contact portions between adjacent drive substrates. This allows a display area DA in which joints are hardly visually recognized to be formed.

Next, a display device according to another embodiment will be described. In other embodiments described below, the same components as those of the display device in the first embodiment described above are denoted by the same reference numerals as those in the first embodiment, and a detailed description thereof may be simplified or omitted. Parts different from those of the first embodiment will be mainly described in detail.

### Second Embodiment

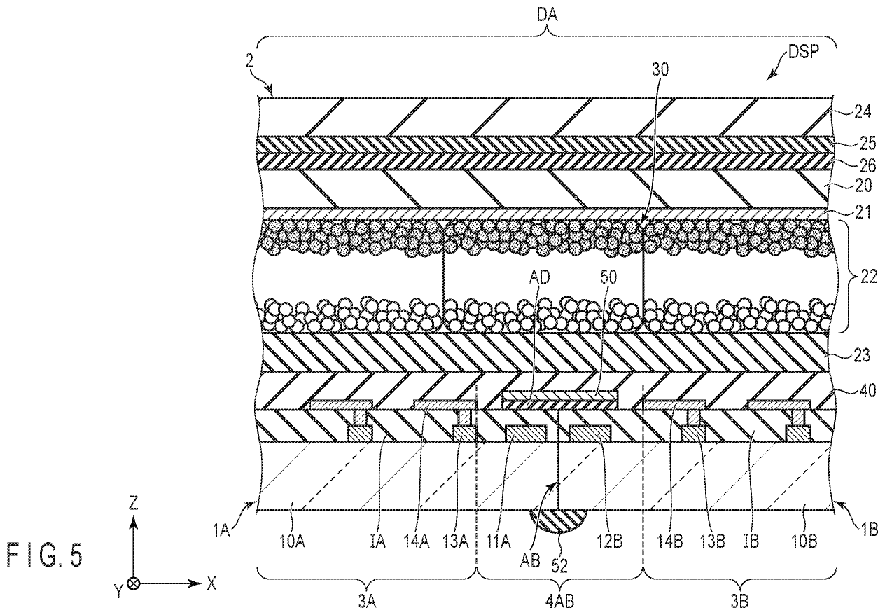

FIG. 5 is a cross-sectional view illustrating a display device DSP of a second embodiment. The second embodiment is different from the above-mentioned first embodiment in that a conductive layer 50 is provided between the drive circuit 11A and the electrophoretic layer 22 and between the drive circuit 12B and the electrophoretic layer 22. The conductive layer 50 is, for example, a film-shaped electrode formed of a metal layer different from a pixel electrode, such as an aluminum foil. Such conductive layer 50 is provided in a sub-area 4AB via a sticking layer AD such as an adhesive or a double-faced tape. In the example illustrated in FIG. 5, the conductive layer 50 is located on the same layer as pixel electrodes 14A and 14B and preferably on insulating films IA and IB, and is covered with an adhesive layer 40. Incidentally, the conductive layer 50 may be provided between the adhesive layer 40 and a base 23.

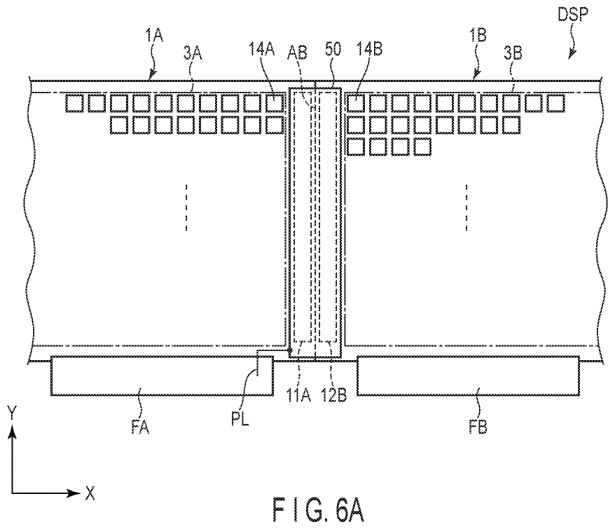

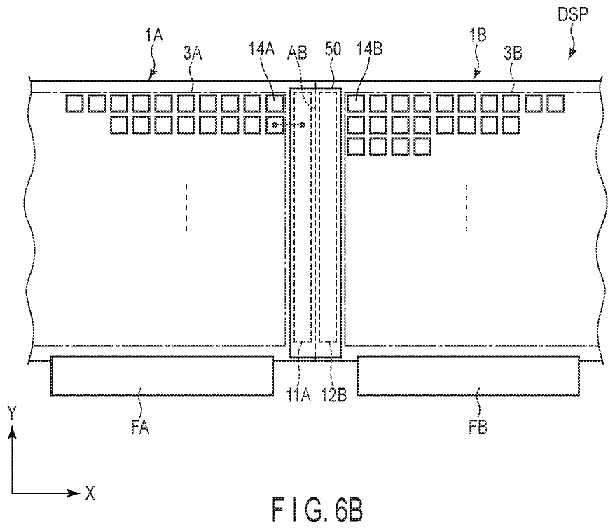

FIG. 6A is a plane view of the display device DSP including a conductive layer 50 illustrated in FIG. 5. Incidentally, a counter-substrate 2 is not illustrated here. The conductive layer 50 extends along a contact portion AB and is formed in a strip shape. In planar view, the conductive layer 50 overlaps the drive circuit 11A, the drive circuit 12B, and a gap between these circuits.

A flexible printed circuit board FA is connected to a drive substrate 1A. A flexible printed circuit board FB is connected to a drive substrate 1B. The conductive layer 50 is interposed between the flexible printed circuit board FA and the flexible printed circuit board FB. In the example illustrated in FIG. 6A, the conductive layer 50 is electrically connected to a power line PL provided on the flexible printed circuit board FA. Incidentally, the conductive layer 50 may be electrically connected to a power line of the flexible printed circuit board FB. In addition, the conductive layer 50 may be formed integrally with a conductive layer of the flexible printed circuit board FA or FB.

The power line PL is, for example, a first power line having an electric potential for black display or a second power line having an electric potential for white display. In the example illustrated in FIG. 6A, the conductive layer 50 is directly connected to the power line PL. Incidentally, the conductive layer 50 may be electrically connected to a switch that selectively switches connection between the first power line and the second power line. Alternatively, as illustrated in FIG. 6B, the conductive layer 50 may be electrically connected to an adjacent pixel electrode 14A. In addition, the conductive layer 50 may be electrically connected to an adjacent pixel electrode 14B.

According to the second embodiment, by supplying the conductive layer 50 with a predetermined electric potential equal to the pixel potential, an electric field is formed between the conductive layer 50 and a common electrode 21. As a result, the electrophoretic layer 22 overlapping the contact portion AB, the drive circuit 11A, and the drive circuit 12B is driven. Therefore, a display area DA is formed over an active area 3A, the sub-area 4AB, and an active area 3B.

Incidentally, in the second embodiment, since the electrophoretic layer 22 of the sub-area 4AB is driven by a single conductive layer 50, the same display is performed over the sub-area 4AB. In addition, since the conductive layer 50 is formed in a strip shape extending in the second direction Y, it is suitable for displaying a vertical line (partition line) extending in the second direction Y between the active area 3A and the active area 3B or displaying a solid pattern having the same color as the display colors of the outermost peripheries of the active areas 3A and 3B.

### Third Embodiment

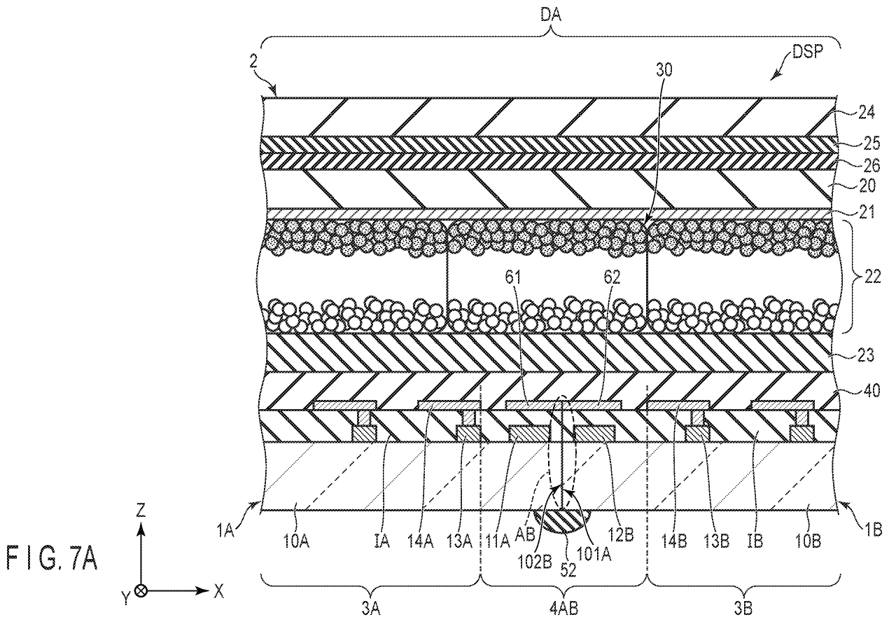

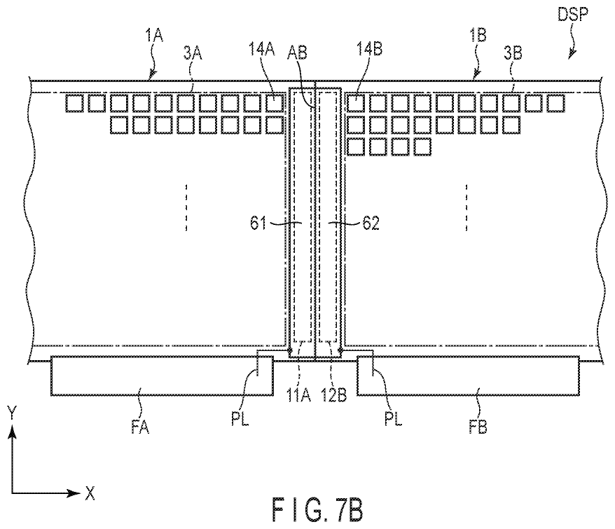

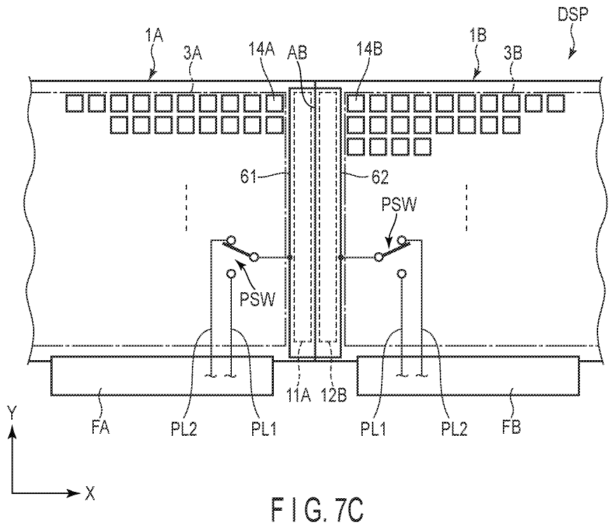

FIG. 7A is a cross-sectional view illustrating a display device DSP of a third embodiment. The third embodiment is different from the above-mentioned first embodiment in that a first electrode 61 is provided between the drive circuit 11A and the electrophoretic layer 22 and a second electrode 62 is provided between the drive circuit 12B and the electrophoretic layer 22. The first electrode 61 is provided in the same layer as a pixel electrode 14A, and is formed of the same material as the pixel electrode 14A. The second electrode 62 is provided in the same layer as a pixel electrode 14B, and is formed of the same material as the pixel electrode 14B. The first electrode 61 and the second electrode 62 are, for example, transparent electrodes formed of ITO.

In the example illustrated in FIG. 7A, the first electrode 61 is in contact with the second electrode 62 and is electrically connected to each other. That is, the first electrode 61 extends to directly above an end portion 101A of a base 10A, and the second electrode 62 extends to directly above an end portion 102B of a base 10B. Then, in a contact portion AB, the end portion 101A and the end portion 102B are in contact with each other, and the first electrode 61 and the second electrode 62 are in contact with each other. Incidentally, the term “contact” between the electrodes here includes not only a state in which the substrates abut on each other but also a state in which the substrates are opposed to each other with a slight gap interposed therebetween and are provided close to each other to such an extent that the gap can be ignored in terms of structure. It is also possible to adopt a configuration in which the first electrode 61 and the second electrode 62 are connected via an adhesive having conductivity.

Either one of the first electrode 61 or the second electrode 62 is electrically connected to a power line PL as illustrated in FIG. 6A, for example. As illustrated in FIG. 7B, both the first electrode 61 and the second electrode 62 may be electrically connected to a power line PL having the same electric potential. Alternatively, as illustrated in FIG. 7C, either one of the first electrode 61 and the second electrode 62 may be electrically connected to a switch PSW that selectively switches connection between a first power line PL1 and a second power line PL2. Alternatively, either one of the first electrode 61 or the second electrode 62 may be electrically connected to an adjacent pixel electrode 14A or an adjacent pixel electrode 14B.

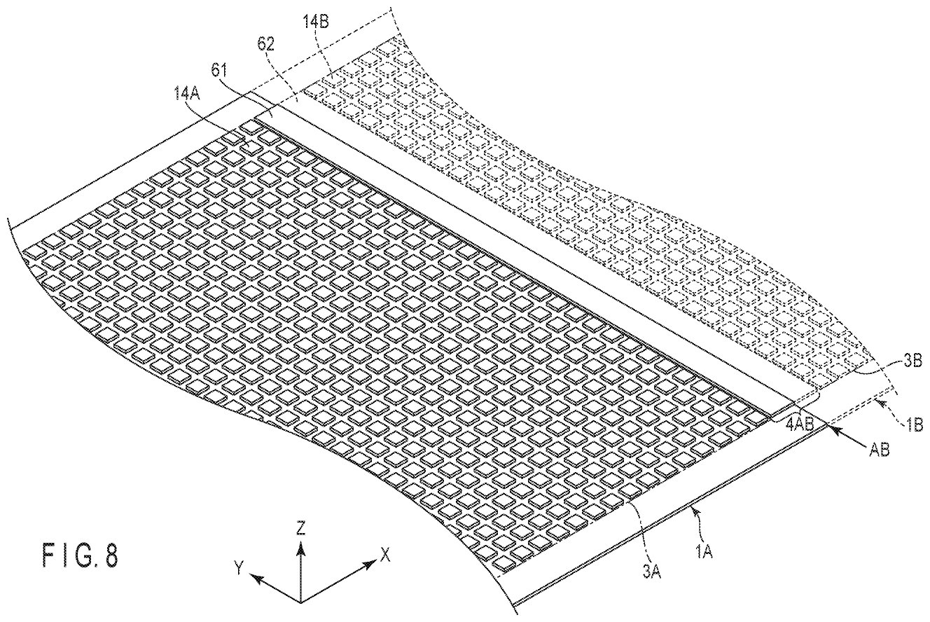

FIG. 8 is a perspective view illustrating a configuration example of the first electrode 61 applicable to the third embodiment. Incidentally, the second electrode 62 is indicated by dotted lines.

The first electrode 61 and the second electrode 62 extend along the contact portion AB, and are each formed in a strip shape extending in the second direction Y. Incidentally, the end portion of the first electrode 61 facing the second electrode 62 and the end portion of the second electrode 62 facing the first electrode 61 may be in contact with each other entirely or partially.

Even in the third embodiment, the same effect as in the second embodiment can be obtained.

### Fourth Embodiment

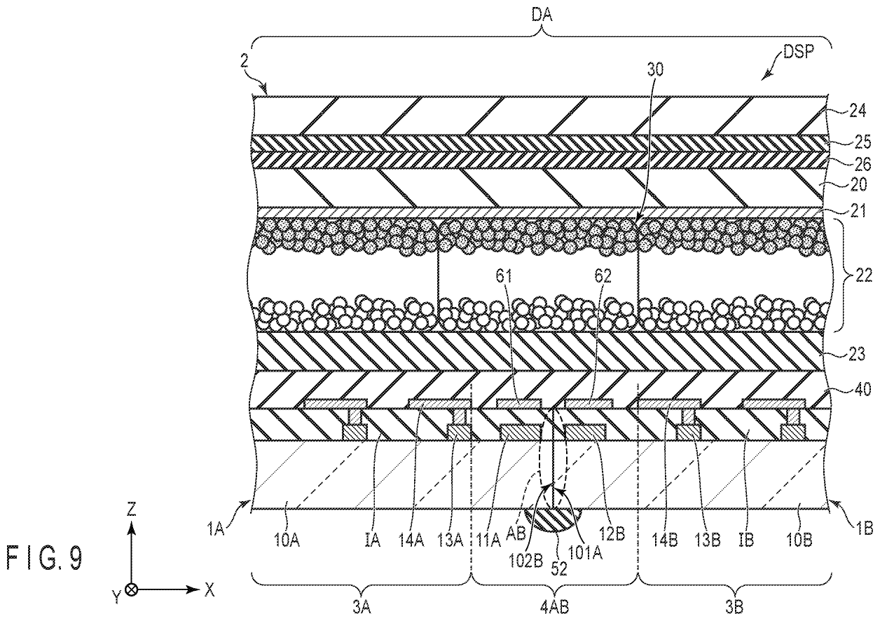

FIG. 9 is a cross-sectional view illustrating a display device DSP of a fourth embodiment. The fourth embodiment is different from the above-mentioned third embodiment in that the first electrode 61 is spaced apart from the second electrode 62. In other words, at least one of the first electrode 61 and the second electrode 62 is formed so as not to overlap a contact portion AB.

The first electrode 61 and the second electrode 62 are each electrically connected to the power line PL as illustrated in FIG. 6A. Incidentally, similarly to FIG. 7C, each of the first electrode 61 and the second electrode 62 may be electrically connected to the switch PSW that selectively switches connection between the first power line PL1 and the second power line PL2 described above. The first electrode 61 may be electrically connected to an adjacent pixel electrode 14A, and the second electrode 62 may be electrically connected to an adjacent pixel electrode 14B.

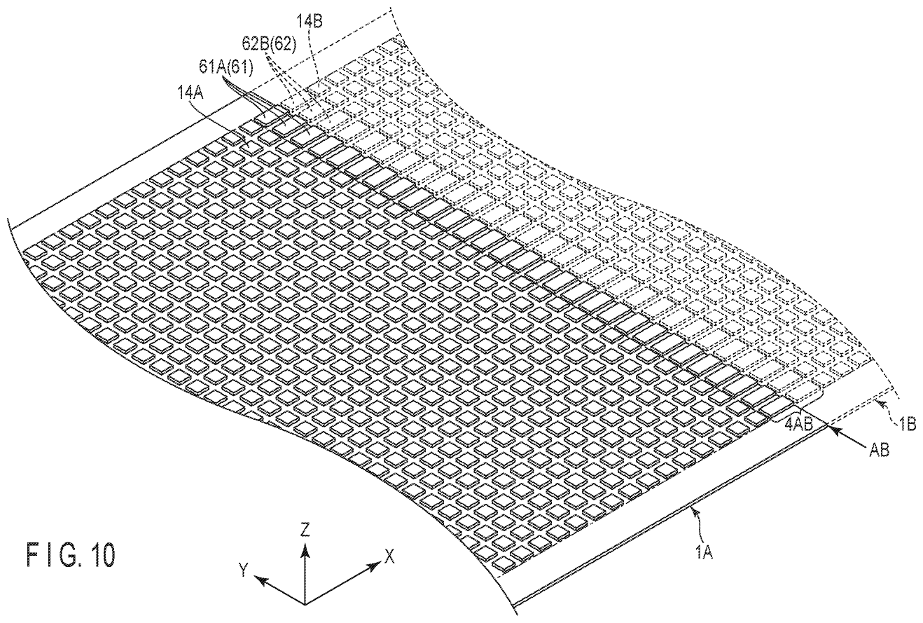

FIG. 10 is a perspective view illustrating a configuration example of the first electrode 61 applicable to the fourth embodiment. Incidentally, the second electrode 62 is indicated by dotted lines.

The first electrode 61 is formed with a plurality of electrode elements 61A arranged along the contact portion AB, and the second electrode 62 is formed with a plurality of electrode elements 62B arranged along the contact portion AB. For example, the number of the plurality of electrode elements 61A may be the same as the number of pixel electrodes 14A arranged in the second direction Y, and a pitch of the electrode element 61A is equal to a pitch of the pixel electrode 14A. The plurality of electrode elements 62B are also configured in the same manner as the electrode elements 61A. The electrode elements 61A and the electrode elements 62B are arranged spaced apart in the first direction X with the contact portion AB interposed therebetween, and are insulated from each other.

In such configuration example, an electrophoretic layer 22 of a sub-area 4AB is driven by the plurality of electrode elements 61A and 62B arranged in the second direction Y. In addition, each of the electrode elements 61A and each of the electrode elements 62B can be supplied with individual electric potentials. For this reason, in the sub-area 4AB, not only the same display pattern entirely but also various patterns such as horizontal lines extending in the first direction X can be displayed.

Even if the electrode elements 62B are disposed to be shifted in the second direction Y with respect to the electrode elements 61A, the electrode elements 61A and 62B are insulated from each other and are supplied with individual electric potentials, so that there is no influence on the display in the sub-area 4AB.

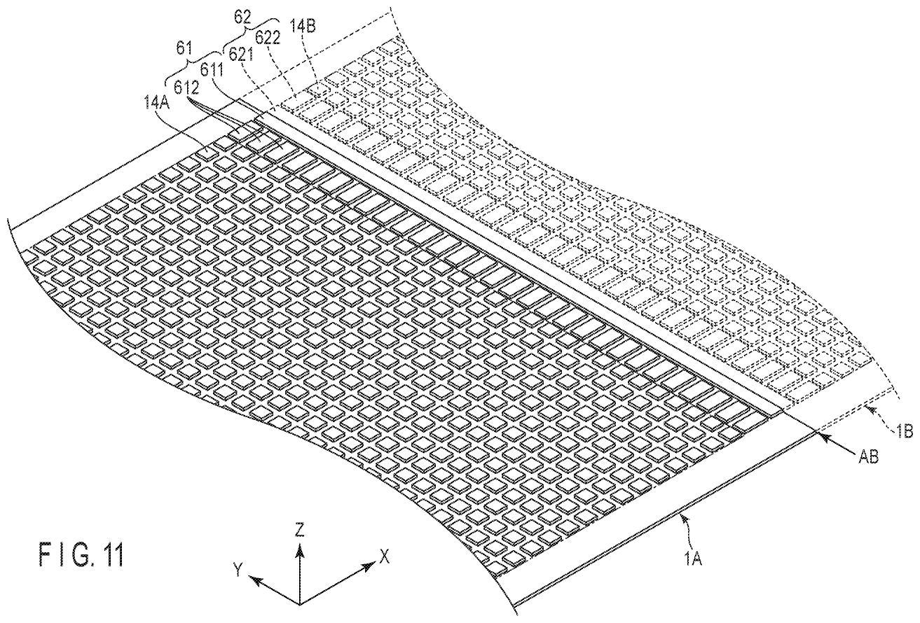

FIG. 11 is a perspective view illustrating another configuration example of the first electrode 61 applicable to the fourth embodiment. The first electrode 61 is formed with a first electrode element 611 extending along the contact portion AB, and a plurality of second electrode elements 612 arranged along the contact portion AB. The first electrode element 611 is formed in a strip shape extending in the second direction Y. The plurality of second electrode elements 612 are located between the first electrode element 611 and the pixel electrodes 14A, and are arranged in the second direction Y. Similarly to the first electrode 61, the second electrode 62 is also formed with a first electrode element 621 and a plurality of second electrode elements 622.

The first electrode elements 611 and 621 are arranged spaced apart in the first direction X with the contact portion AB interposed therebetween. Incidentally, as described in the third embodiment, the first electrode elements 611 and 621 may be in contact with each other.

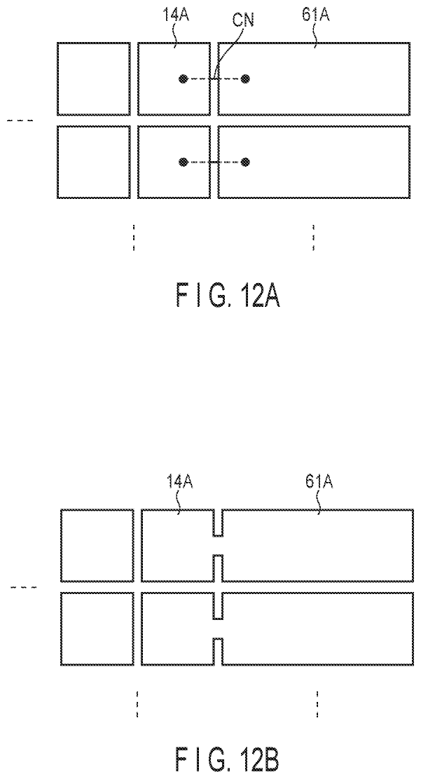

FIGS. 12A and 12B are plane views for explaining a configuration example of connection between the pixel electrode 14A and the electrode element 61A illustrated in FIG. 10.

In the example illustrated in FIG. 12A, the pixel electrode 14A and the electrode element 61A that are adjacent to each other are electrically connected to each other through a connection line CN. Such a connection line CN can be formed of, for example, a metal material in the same layer as the scanning line GL, a metal material in the same layer as the signal line SL, or a transparent conductive material in the same layer as the capacitive electrode CE, as described with reference to FIG. 4.

In the example illustrated in FIG. 12B, the pixel electrode 14A and the electrode element 61A that are adjacent to each other are integrally formed.

The connection structure described here can also be applied to the connection structure between the pixel electrode 14B and the electrode element 62B illustrated in FIG. 10, and the connection structure between the pixel electrode 14A and the second electrode element 612, and the connection structure between the pixel electrode 14B and the second electrode element 622 illustrated in FIG. 11.

### Fifth Embodiment

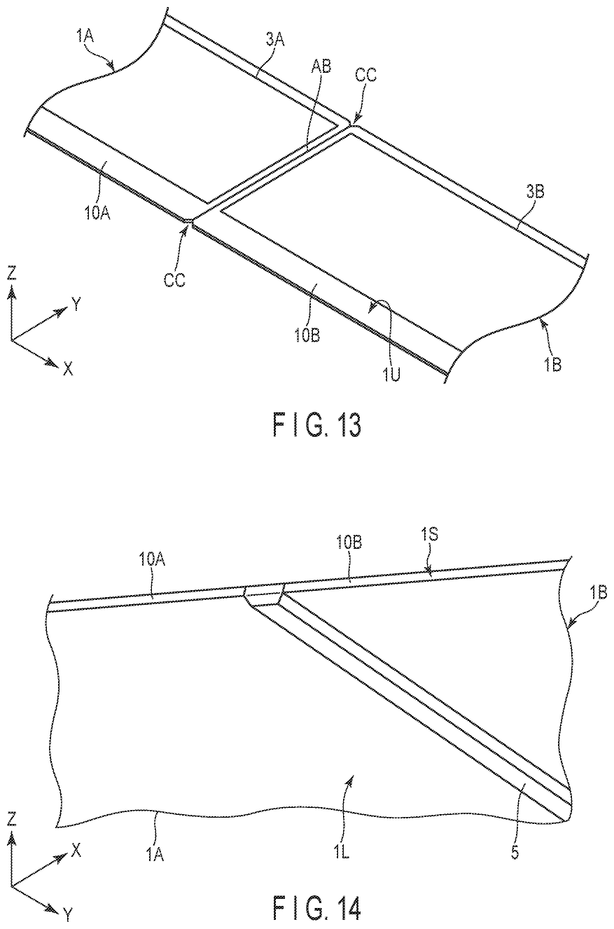

FIG. 13 is a perspective view of bases 10A and 10B of a fifth embodiment as viewed from an upper surface 1U side. Incidentally, a counter-substrate 2 and a moisture-proof material 5 are not illustrated here. The bases 10A and 10B each have a concavity CC at both ends in the direction (second direction Y) in which a contact portion AB extends. For example, each of the bases 10A and 10B has chamfered corners, and when the base 10A and the base 10B are butted against each other, the chamfered portions form the concavity CC. When viewed from the base 10A, the base 10A is spaced apart from the base 10B at both ends sandwiching the contact portion AB, and when viewed from the base 10B, the base 10B is spaced apart from the base 10A at both ends sandwiching the contact portion AB.

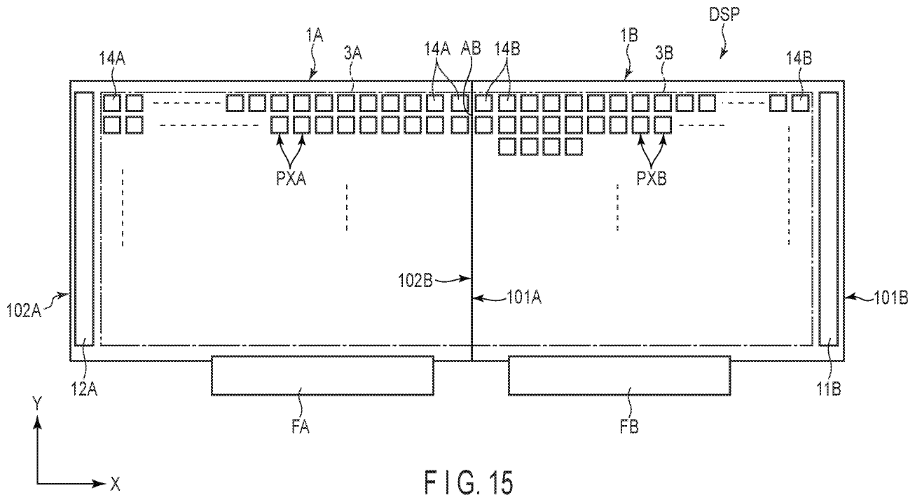

FIG. 14 is a perspective view of the bases 10A and 10B as viewed from a lower surface 1L side. When the moisture-proof material 5 is formed along the contact portion AB illustrated in FIG. 13, the concavity CC is filled with the moisture-proof material 5. This allows the amount of the moisture-proof material 5 protruded from a side surface 1S to be reduced, resulting in reduction in outer dimensions of the display device DSP.

### Sixth Embodiment

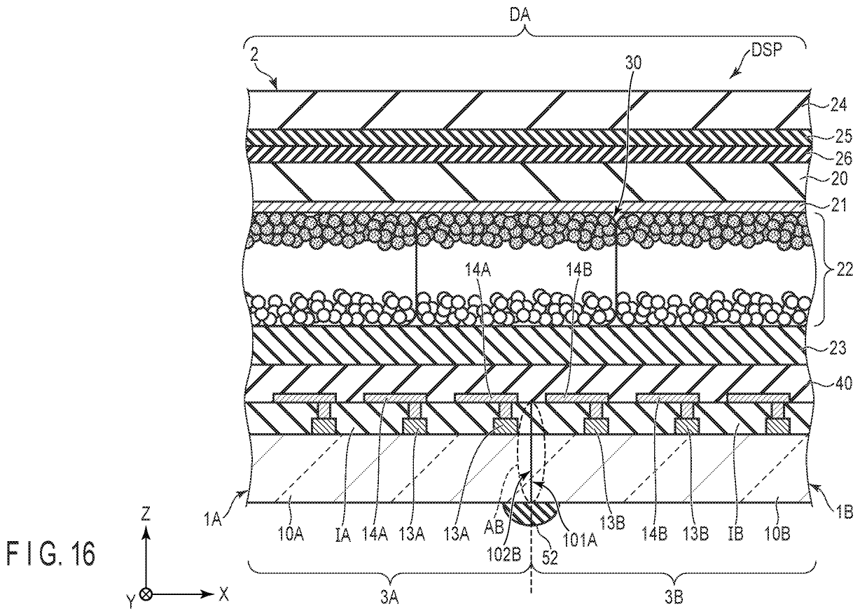

FIG. 15 is a plane view illustrating a display device DSP of a sixth embodiment. The sixth embodiment is different from the above-mentioned embodiment in that the pixel electrode 14A of the drive substrate 1A and the pixel electrode 14B of the drive substrate 1B are adjacent to each other with the contact portion AB interposed therebetween. In other words, in the display device DSP of the sixth embodiment, a sub-area 4AB is not included, and active areas 3A and 3B are adjacent to each other.

A drive circuit 12A of the drive substrate 1A is provided between the pixel electrode 14A located at the outermost periphery of the active area 3A and an end portion 102A on a side opposite to an end portion 101A in the first direction X. The drive circuit 12A includes a gate driver that scans all pixel rows in the active area 3A. Incidentally, the pixel row includes pixel electrodes or pixels arranged in the first direction X. In the drive substrate 1A, no drive circuit is provided in an area along the end portion 101A.

A drive circuit 11B of the drive substrate 1B is provided between the pixel electrode 14B located at the outermost periphery of the active area 3B and an end portion 101B on a side opposite to an end portion 102B in the first direction X. The drive circuit 12B includes a gate driver that scans all pixel rows in the active area 3B. In the drive substrate 1B, no drive circuit is provided in an area along the end portion 102B.

FIG. 16 is a cross-sectional view of the display device DSP illustrated in FIG. 15. Like other pixel electrodes 14A, a pixel electrode 14A close to the end portion 101A in the drive substrate 1A is electrically connected to a switching element 13A. Like other pixel electrodes 14B, a pixel electrode 14B close to the end portion 102B in the drive substrate 1B is electrically connected to a switching element 13B.

A pitch between the pixel electrode 14A and the pixel electrode 14B is substantially equal to a pitch of the pixel electrode 14A in the active area 3A or a pitch of the pixel electrode 14B in the active area 3B. For this reason, in the display area DA, an image can be displayed in the vicinity of the contact portion AB as well as the other areas, and the joint is hardly visually recognized.

### Seventh Embodiment

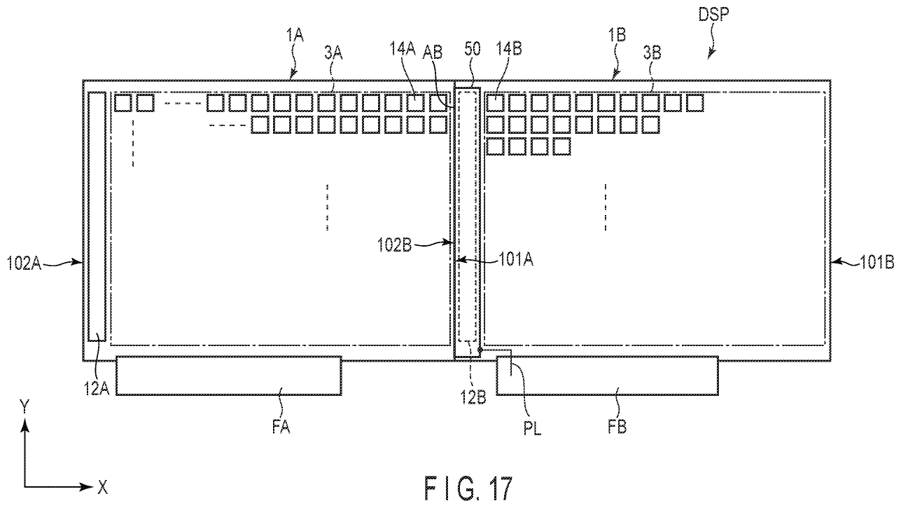

FIG. 17 is a plane view illustrating a display device DSP of a seventh embodiment. The seventh embodiment is different from the sixth embodiment in the configuration of the drive substrate 1B. Specifically, a drive circuit 12B of the drive substrate 1B is provided between a pixel electrode 14B located at the outermost periphery of an active area 3B and an end portion 102B in the first direction X. That is, the drive circuit 12B is located between a pixel electrode 14A of a drive substrate 1A and the pixel electrode 14B of the drive substrate 1B. A conductive layer 50 overlaps the drive circuit 12B in planar view. The conductive layer 50 is electrically connected to a power line PL provided on a flexible printed circuit board FB.

Such drive substrate 1B has the same configuration as the drive substrate 1A except that the conductive layer 50 is provided. For this reason, a large display device DSP can be realized by arranging substantially the same drive substrates side by side. In addition, cost is reduced as compared with a case of preparing a plurality of drive substrates having different configurations.

As described above, according to the present embodiment, it is possible to provide a display device capable of achieving a large screen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first drive substrate comprising
a first base having a first end portion,
a plurality of first pixel electrodes arranged along the first end portion, and
a first drive circuit provided between the plurality of first pixel electrodes and the first end portion;
a second drive substrate that is separate from the first drive substrate and comprises
a second base having a second end portion in contact with the first end portion,
a plurality of second pixel electrodes arranged along the second end portion, and
a second drive circuit provided between the plurality of second pixel electrodes and the second end portion; and
a counter-substrate comprising
a support base opposed to the first drive substrate and the second drive substrate, and
an electrophoretic layer provided between the first drive substrate and the support base and between the second drive substrate and the support base,
wherein the first end portion of the first base and the second end portion of the second base are in contact with each other to form a contact portion, and
the electrophoretic layer overlaps the plurality of first pixel electrodes, the first drive circuit, the contact portion, the second drive circuit, and the plurality of second pixel electrodes.

2. The display device according to claim 1,
wherein the electrophoretic layer comprises a plurality of microcapsules containing electrophoretic particles, and
at least one of the microcapsules overlaps the contact portion.

3. The display device according to claim 1, further comprising a conductive layer provided between the first drive circuit and the electrophoretic layer and between the second drive circuit and the electrophoretic layer.

4. The display device according to claim 3, wherein the conductive layer extends along the contact portion.

5. The display device according to claim 1,
wherein the first drive substrate further comprises a first electrode provided between the first drive circuit and the electrophoretic layer, and
the second drive substrate further comprises a second electrode provided between the second drive circuit and the electrophoretic layer.

6. The display device according to claim 5,
wherein the first electrode is formed of a same material as the first pixel electrode, and
the second electrode is formed of a same material as the second pixel electrode.

7. The display device according to claim 5, wherein the first electrode is in contact with the second electrode.

8. The display device according to claim 7, wherein the first electrode extends along the contact portion.

9. The display device according to claim 5, wherein the first electrode is spaced apart from the second electrode.

10. The display device according to claim 9, wherein the first electrode is formed with a plurality of electrode elements arranged along the contact portion.

11. The display device according to claim 10, wherein one of the electrode elements is adjacent to and electrically connected to one of the plurality of first pixel electrodes.

12. The display device according to claim 5, wherein the first electrode is formed with a first electrode element having a long length extending along the contact portion, and a plurality of second electrode elements arranged along the contact portion between the first electrode element and the plurality of first pixel electrodes.

13. The display device according to claim 1, further comprising a moisture-proof material,
wherein the moisture-proof material comprises a first part covering a side surface of the counter-substrate and a second part covering the contact portion.

14. The display device according to claim 13,
wherein the first base and the second base each have a concavity at both ends in a direction in which the contact portion extends, and
the concavity is filled with the moisture-proof material.

15. The display device according to claim 8, wherein the first electrode is electrically connected to one of the plurality of first pixel electrodes.

16. The display device according to claim 13, further comprising a conductive layer provided between the first drive circuit and the electrophoretic layer and between the second drive circuit and the electrophoretic layer,
wherein the conductive layer is opposed to the second part with the first drive circuit and the second drive circuit interposed therebetween.

17. The display device according to claim 13,
wherein the first drive substrate further comprises a first electrode provided between the first drive circuit and the electrophoretic layer,
the second drive substrate further comprises a second electrode provided between the second drive circuit and the electrophoretic layer, and
the first electrode and the second electrode are opposed to the second part with the first drive circuit and the second drive circuit interposed therebetween.
